(19) United States
(12) Patent Application Publication
(10) Pub. No.: US 2026/0074861 A1
(43) Pub. Date: Mar. 12, 2026

(54) OPERATING IN A NETWORK WITH VARIABLE POWER

(71) Applicant: InterDigital Patent Holdings, Inc., Wilmington, DE (US)

(72) Inventors: Paul Marinier, Brossard (CA); Moon-il Lee, Melville, NY (US); Faris Alfarhan, Montreal (CA); Virgil Comsa, Montreal (CA); Janet A. Stern-Berkowitz, Little Neck, NY (US)

(73) Assignee: InterDigital Patent Holdings, Inc., Wilmington, DE (US)

(21) Appl. No.: 19/102,522

(22) PCT Filed: Aug. 8, 2023
(86) PCT No.: PCT/US2023/029691

§ 371 Date: Feb. 10, 2025

Related U.S. Application Data
(60) Provisional application No. 63/395,997, filed on Aug. 8, 2022.

(51) Int. Cl. H04L 5/00; H04W 24/10; H04W 72/044; H04W 72/231

(52) U.S. Cl. CPC H04L 5/0051; H04W 24/10; H04W 72/0473; H04W 72/231

(57) ABSTRACT

Systems, methods, and instrumentalities are described herein GROUP B for wireless transmit/receive unit (WTRU) operation in a network with variable power transmissions (e.g., based on an energy saving mode of operation). A device (e.g., a WTRU) may be configured to perform one or more actions. The device may receive configuration information indicating a power offset associated with a channel state information reference signal (CSI-RS) resource. The device may receive a power offset change for the CSI-RS resource. The device may determine an adjusted power offset associated with GROUP A the CSI-RS resource based on the power offset and the power offset change. The device may determine CSI feedback for the first CSI-RS resource based on a measurement associated with the first CSI-RS resource and the adjusted power offset. The device may send a send a CSI feedback report. WO

### CROSS-REFERENCE TO RELATED APPLICATIONS

This application claims the benefit of U.S. Provisional Application No. 63/395,997, filed Aug. 8, 2022, the contents of which is incorporated by reference herein.

### BACKGROUND

Mobile communications using wireless communication continue to evolve. A fifth generation may be referred to as 5G. A previous (legacy) generation of mobile communication may be, for example, fourth generation (4G) long term evolution (LTE).

### SUMMARY

Systems, methods, and instrumentalities are described herein for wireless transmit/receive unit (WTRU) operation in a network with variable power transmissions (e.g., based on an energy saving mode of operation). A WTRU may report channel state information (CSI), for example, using relevant assumptions for physical downlink shared channel (PDSCH) transmission power, which may change dynamically and/or without incurring excessive overhead. Assistance information may be provided for a network to set downlink transmission power. A WTRU may receive a configuration for groups of non-zero power (NZP) CSI reference signal (CSI-RS) resources. A WTRU may receive dynamic signaling, which may indicate a power ratio and/or a subset of antenna ports applicable to a group of resources. A WTRU may report CSI, which may include reporting long-term CSI. A WTRU may report a recommended NZP CSI-RS to PDSCH power ratio, for example, based on a modulation and coding scheme (MCS) that meets WTRU requirements.

A device (e.g., a WTRU) may include one or more of: a memory, a receiver and a transmitter (e.g., a transceiver), or a processor, where the device is configured to perform one or more actions. The device may receive configuration information. The configuration information may indicate a power offset associated with a first channel state information reference signal (CSI-RS) resource. The device may receive a power offset change for the first CSI-RS resource. The device may determine an adjusted power offset associated with the first CSI-RS resource based on the power offset associated with the first CSI-RS resource and the power offset change for the first CSI-RS resource. The device may determine CSI feedback for the first CSI-RS resource based on a measurement associated with the first CSI-RS resource and the adjusted power offset associated with the first CSI-RS resource. The device may send a send a CSI feedback report. The CSI feedback report may indicate the CSI feedback for the first CSI-RS resource.

The configuration information may indicate a power offset associated with a second CSI-RS resource. The device may receive a power offset change for the second CSI-RS resource. The device may determine an adjusted power offset associated with the second CSI-RS resource based on the power offset associated with the second CSI-RS resource and the power offset change for the second CSI-RS resource. The device may determine CSI feedback for the second CSI-RS resource based on a measurement associated with the second CSI-RS resource and the adjusted power offset associated with the second CSI-RS resource. The CSI feedback report may include an indication of the CSI feedback for the second CSI-RS resource.

The CSI feedback report may include an indication of the adjusted power offset associated with the first CSI-RS resource and the adjusted power offset associated with the second CSI-RS resource.

The first CSI-RS resource may be a first non-zero-power (NZP) CSI-RS resource and the adjusted power offset associated with the first CSI-RS resource may be determined to be a ratio of physical downlink shared channel (PDSCH) energy-per-resource-element (EPRE) to NZP CSI-RS EPRE.

The first CSI-RS resource may be a first non-zero-power (NZP) CSI-RS resource. The configuration information may include a NES state index, a number of antenna ports associated to the NES state index, and/or an association of a variable antenna ports group to the first CSI-RS resource. The device may determine a number of antenna ports for the first CSI-RS resource based on the number of antenna ports associated to the NES state index.

The CSI feedback report may be based on the determined number of antenna ports for the first CSI-RS resource.

The adjusted power offset associated with the first CSI-RS resource may be the sum of the power offset associated with the first CSI-RS resource and the power offset change for the first CSI-RS resource.

A method for wireless transmit/receive unit (WTRU) operation in a network with variable power transmissions (e.g., based on an energy saving mode of operation) may be performed. The method may include receiving configuration information. The configuration information may indicate a power offset associated with a first channel state information reference signal (CSI-RS) resource. The method may include receiving a power offset change for the first CSI-RS resource. The method may include determining an adjusted power offset associated with the first CSI-RS resource based on the power offset associated with the first CSI-RS resource and the power offset change for the first CSI-RS power offset group. The method may include determining CSI feedback for the first CSI-RS resource based on a measurement associated with the first CSI-RS resource and the adjusted power offset associated with the first CSI-RS resource. The method may include sending a CSI feedback report. The CSI feedback report may include an indication of the CSI feedback for the first CSI-RS resource.

The configuration information may indicate a power offset associated with a second CSI-RS resource. The method may include receiving a power offset change for the second CSI-RS resource, determining an adjusted power offset associated with the second CSI-RS resource based on the second power offset associated with the second CSI-RS resource and the power offset change for the second CSI-RS resource, and determining CSI feedback for the second CSI-RS resource based on a measurement associated with the second CSI-RS resource and the adjusted power offset associated with the second CSI-RS resource. The CSI feedback report may include an indication of the CSI feedback for the second CSI-RS resource.

A device (e.g., a WTRU) may include one or more of: a memory, a receiver and a transmitter (e.g., a transceiver), or a processor, where the device is configured to perform one or more actions. The device may receive configuration information. The device may receive configuration information, wherein the configuration information indicates a first power offset associated with a first channel state information reference signal (CSI-RS) resource. The device may receive a second power offset associated with the first CSI-RS resource. The device may determine CSI feedback based on a measurement associated with the first CSI-RS resource and the second power offset. The device may send a CSI feedback report. The CSI feedback report may include an indication of the CSI feedback.

The configuration information may indicate that the first CSI-RS resource is associated with a first CSI-RS power offset group.

The indication of the second power offset may be received after the indication of the first power offset. The device may determine that the second power offset is a last received power offset. The device may to determine CSI feedback based on the last received power offset (e.g., the second power offset).

Use of a power offset in the determination of the CSI feedback may be limited to use of the last received power offset.

### BRIEF DESCRIPTION OF THE DRAWINGS

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example of dynamic power adaptation for CSI measurements and feedback in a variable power network.

### EXAMPLE NETWORKS FOR IMPLEMENTATION OF THE EMBODIMENTS

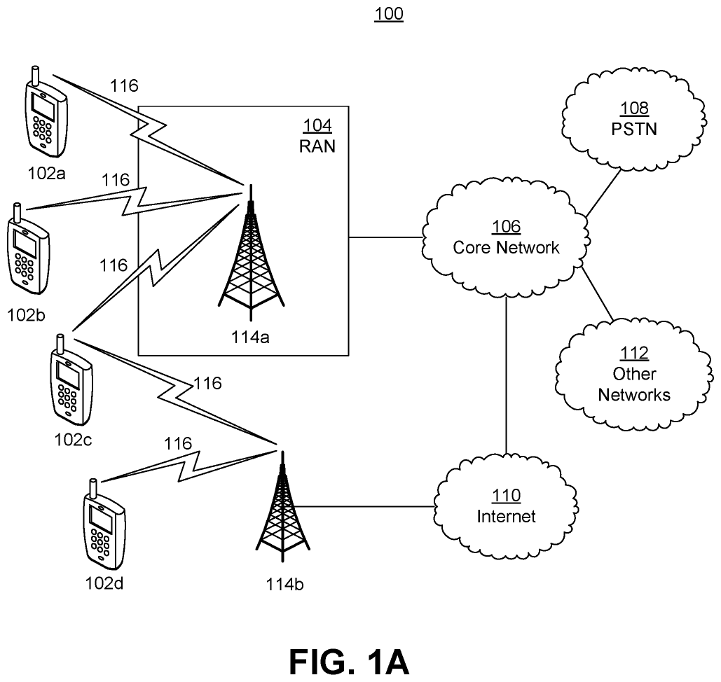

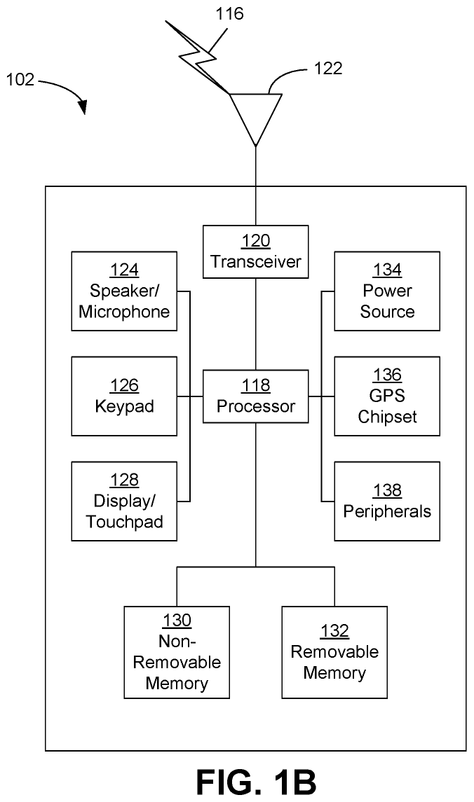

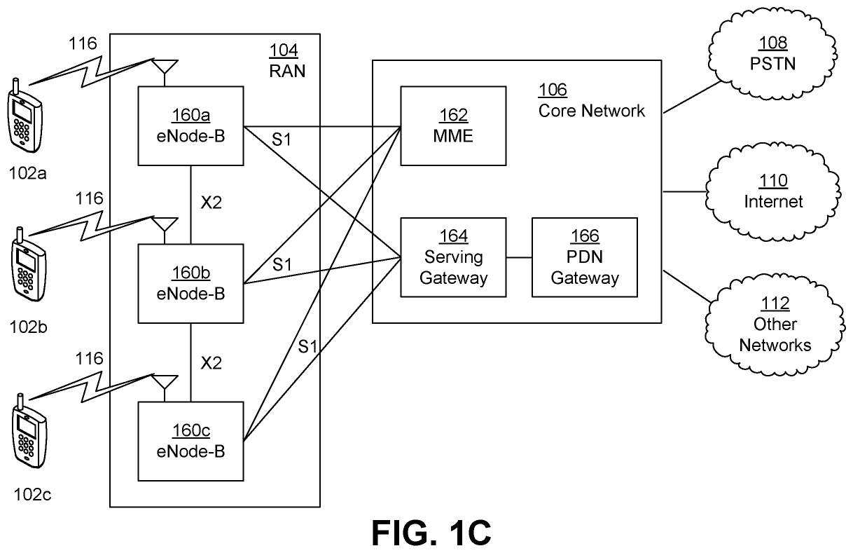

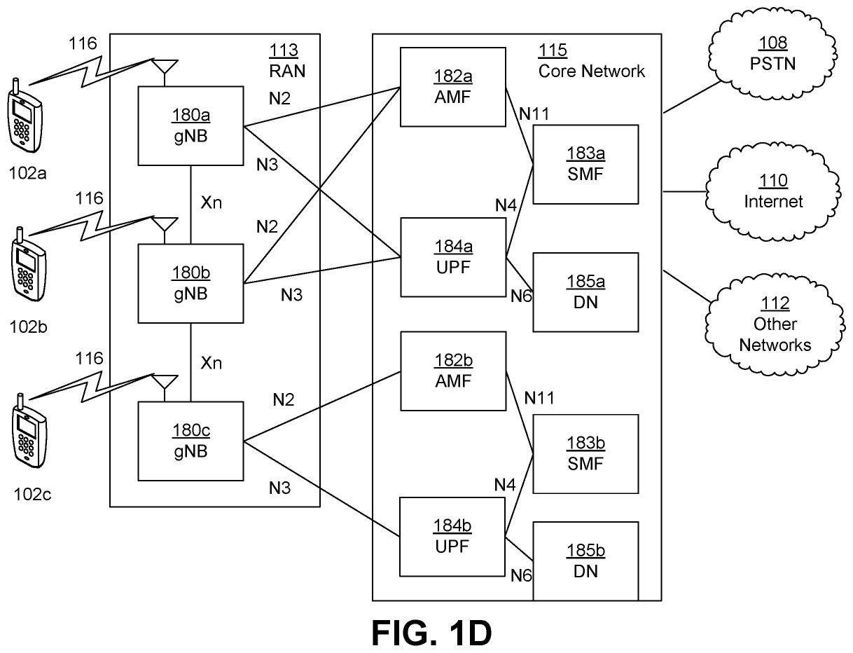

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VolP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUS 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QOS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A radio access network (e.g., 3GPP RAN) may implement network energy savings. A network may minimize its power consumption for transmission and/or reception. Minimization of power consumption may be beneficial to reduce operational costs and improve environmental sustainability.

A network (e.g., new radio (NR)) may be (e.g., very) efficient, for example, from the perspective of minimizing transmissions from the network when there is no data. A network (e.g., NR) may not utilize an always-on cell-specific reference signal (CRS). Energy consumption may be (e.g., additionally and/or alternatively) reduced, for example, as described herein.

For example, a network may consume energy when not transmitting for other activities, such as baseband (e.g., digital) processing for reception or beamforming. Such “idle” power consumption may be considerable in dense networks (e.g., even when there are not any WTRUs being served during a given period). Energy consumption may be reduced, for example, if the network turns off these activities when not transmitting to a WTRU.

A network (e.g., NR) may support beamforming with multiple (e.g., many) ports (e.g., up to 64 transmit and receive ports). Energy consumption may increase with the number of ports utilized. The utilization of a maximum number of ports may not be necessary for all WTRUs. Energy consumption may be reduced, for example, if the network can adapt the number of ports (e.g., to only the number of ports required).

Network energy savings may improve the operation of the cellular eco-system to enable more efficient adaptation of network transmissions and receptions resources in the time, frequency, spatial, and power domains (e.g., with support, feedback, and/or other assistance from WTRUs). An echo-friendly WTRU operation may support deployment of greener network deployments that allow reduced emissions and/or reduced operating expense (OPEX) costs of operating cellular networks. Some networks (e.g., NR) may (e.g., unlike other networks, such as long term evolution (LTE) not require transmission of always-on synch or reference signals and/or may support adaptable bandwidth and multiple input multiple output (MIMO) capabilities. Power conservation may be implemented without impacting some WTRUs (e.g., legacy WTRUs). Adaptation of network resources may enable greater efficiency in operating newer deployments and later generations.

Channel state information (CSI) may include, for example, one or more of the following: a channel quality index (CQI); a rank indicator (RI); a precoding matrix index (PMI); an L1 channel measurement (e.g., a reference signal received power (RSRP), such as an L1-RSRP, or a signal interference to noise ratio (SINR)); a channel state information reference signal (CSI-RS) resource indicator (CRI); a synchronization signal (SS)/physical broadcasting channel (PBCH) block resource indicator (SSBRI); a layer indicator (LI); or any other measurement quantity measured by a WTRU (e.g., from the configured CSI-RS or SS/PBCH block).

Uplink control information (UCI) may include one or more of: a CSI; hybrid automatic repeat request (HARQ) feedback for one or more HARQ processes; a scheduling request (SR); a link recovery request (LRR); a configured grant UCI (CG-UCI); or other control information bits that may be transmitted on a physical uplink control channel (PUCCH) and/or a physical uplink shared channel (PUSCH).

Channel conditions may include conditions relating to the state of a radio/channel, which may be determined by a WTRU, for example, from one or more of the following: a WTRU measurement; L3/mobility-based measurements (e.g., RSRP, reference signal received quality (RSRQ)); a radio link monitoring (RLM) state; and/or channel availability in unlicensed spectrum (e.g., whether the channel is occupied based on determination of a listen-before-talk (LBT) procedure or whether the channel is deemed to have experienced a consistent LBT failure).

A WTRU measurement that may be used to determine channel conditions may include one or more of: L1/SINR/RSRP, a channel quality indicator (CQI), a modulation and coding scheme (MCS), channel occupancy, a received signal strength indicator (RSSI), power headroom, or exposure headroom.

A physical random access channel (PRACH) resource may include one or more of the following: a PRACH resource (e.g., in frequency); a PRACH occasion (RO) (e.g., in time); a preamble format (e.g., in terms of total preamble duration, sequence length, guard time duration, and/or in terms of length of cyclic prefix); or a (e.g., certain) preamble sequence that may be used for the transmission of a preamble in a random access procedure.

A property of scheduling information (e.g., an uplink grant or a downlink assignment) may include, for example, one or more of the following: a frequency allocation; an aspect of time allocation, such as a duration; a priority; a modulation and coding scheme; a transport block size; a number of spatial layers; a number of transport blocks to be carried; a TCI state or SRI; a number of repetitions; or an indication whether the grant is a configured grant type 1, type 2, or a dynamic grant.

An indication by downlink control information (DCI), and/or another indication, may include, for example, one or more of the following: an (e.g., explicit) indication by a DCI field or by a radio network identifier (RNTI) used to mask a cyclic redundancy check (CRC) of the physical downlink control channel (PDCCH); an (e.g., implicit) indication by a property, such as a DCI format, a DCI size, a control resource set (CORESET) and/or search space; an aggregation level; or an identity of a first control channel resource (e.g., index of a first control channel element (CCE)) for a DCI (e.g., where a mapping between a property and a value may be signaled by radio resource control (RRC) and/or medium access control (MAC).

The terms network availability state and network energy savings (NES) state may be used interchangeably.

Network availability states and/or NES states may be provided (e.g., indicated, determined, selected, etc.). A WTRU may determine whether to transmit or receive on resource(s), for example, based on a network availability state, which may imply the node's (e.g., gNB's) power savings status. An availability state may correspond to a network energy savings state or a gNB activity level. An availability state may be uplink and/or downlink specific. An availability state may change from symbol to symbol, slot to slot, frame to frame, and/or on longer duration granularity. An availability state may be determined by the WTRU or indicated by a network (NW). An availability state may be, for example, “on,” “off,” “reduced Tx power,” “dormant,” “micro sleep,” or “deep sleep.” Availability states may be abstracted by NW configuration parameters and/or values. An “Off” availability state may indicate (e.g., imply) that the node's (gNB's) baseband hardware is (e.g., completely) turned off. A “sleep” availability state may indicate that the node (e.g., gNB) may wake up (e.g., periodically) to transmit signal(s) (e.g., presence signals, synchronization, and/or reference signals), and/or receive UL signal(s). In some examples, one or more availability states may have DL and/or UL resource(s) that are not available (e.g., during certain periods of time), which may enable the network to turn off baseband processing and/or other activities (e.g., to reduce power consumption). Some measurement resources (e.g., SSBs or CSI-RS) may (e.g., only) be made available in one or more (e.g., certain) availability states.

A WTRU may (e.g., under certain conditions) transmit a request to the network (e.g., a wake-up request) to modify the availability state to a state that makes one or more resources available for the WTRU. A wake-up request may include a transmission that may be decodable by a (e.g., low-complexity) receiver at the node (e.g., gNB) (e.g., for which energy consumption requirement is minimal). Herein, wake up request, turn on request, and switch on WTRU assistance information may be used interchangeably. In one or more availability states (e.g., “micro sleep” or “deep sleep” states), a wake up request may be (e.g., exclusively) used. A wake-up request may refer to (e.g., be implemented by) a physical uplink signal transmitted by the WTRU to request a change of availability state. A wake-up request signal may be implemented based on a physical layer configuration. A switch-on request may (e.g., otherwise) be a physical layer indication or an L2 indication from the WTRU to the network. A switch-on request indication may be delivered as a MAC CE, UCI, radio resource control (RRC) signalling, a PUCCH, or a RACH indication. A switch-on request indication may include switch on WTRU assistance information and/or a positioning report.

A WTRU may determine an availability state based on (e.g., a reception of) an availability state indication (e.g., from L1/L2 signaling, such as a group common DCI or indication). A WTRU may (e.g., implicitly) determine an availability state form the reception of periodic DL signalling (e.g., or lack thereof). A WTRU may determine whether a resource is available for transmission/reception and/or measurements for a determined network availability state, for example, based on whether the resource(s) are applicable in the active availability state.

An availability state may be applicable to at least one transmission, reception, and/or measurement resource. An availability state may be applicable to at least one time period, such as a time slot and/or a time symbol. An availability state may be applicable to a serving cell, a cell group, a frequency band, a bandwidth part (BWP), a TRP, a set of spatial elements, and/or a range of frequencies within a bandwidth part.

A WTRU may determine the active availability state associated with a cell, carrier, TRP, and/or frequency band to be “Off,” “Deep sleep,” or “Micro sleep,” for example, after reception of DL signaling that changes the cell's or TRP's availability state. For example, a WTRU may receive a turn off command on broadcast signaling, RRC signaling, DCI (e.g., a group common DCI), and/or a DL MAC CE. The WTRU may determine an availability state associated with a cell, carrier, TRP, and/or frequency band, for example, based on reception of an availability state indication (e.g., via L1/L2 signalling, such as a group common DCI or indication).

A WTRU may (e.g., implicitly) determine an availability state associated with a cell, carrier, TRP, and/or frequency band (e.g., “Off,” “deep sleep,” “micro sleep,” or “dormant”), for example, based on one or more of the following: reception of a command or signal indicating a change in availability state; a gNB DTX status (e.g., indicating whether the gNB is in active time or an associated activity timer is running); a lack of detection of a presence indication; a time (e.g., a time of day); the availability state of an associated cell (e.g., another carrier of the same MAC entity, another carrier in the same cell group, another carrier in the same gNB, another sector in the same gNB, and/or a configured associated cell or capacity boosting cell); detection of a PSS (e.g., PSS only) signal and/or an (e.g., a simplified/stripped down) SSB signal; a detection of an RS signal (e.g., CSI-RS, positioning reference signal (PRS), tracking reference signal (TRS)) or the lack thereof; a WTRU's RRC state (e.g., Idle, inactive, or connected mode); whether paging has been received (e.g., within a configured time window); or whether system information (e.g., periodic SI or a subset of SIBs) has been received (e.g., within a configured time window).

A WTRU may (e.g., implicitly) determine an availability state associated with a cell, carrier, TRP, and/or frequency band (e.g., “Off,” “deep sleep,” “micro sleep,” or “dormant”), for example, based on reception of a command or signal indicating a change in availability state, such as a group common DCI in connected mode or RRC signaling. A WTRU may (e.g., implicitly) determine an availability state, for example, based on the reception of periodic DL signaling. A WTRU may be configured or specified to associate an availability state with one or more DL signal types (e.g., SSB, partial SSB), and/or one or more periodicities.

A WTRU may (e.g., implicitly) determine an availability state associated with a cell, carrier, TRP, and/or frequency band (e.g., “Off,” “deep sleep,” “micro sleep,” or “dormant”), for example, based on lack of detection of a presence indication. For example, a WTRU may determine an availability state associated with the cell (e.g., “off” or “deep sleep”) if a presence indication was not detected on one or more presence indication occasion. For example, the WTRU may determine (e.g., assume) or change the cell's availability state based on (e.g., after a number of consecutive) misdetections and/or after a timer expires (e.g., without detection of a presence signal). In some examples, a WTRU may determine an availability state is active or de-active after expiry of a timer associated with the availability state. A WTRU may (e.g., implicitly) determine an availability state, for example, based on a lack of reception of (e.g., periodic) DL signaling. For example, a WTRU may be configured with a signal quality threshold (e.g., an RSRP threshold). The WTRU may determine that the availability state is not active and/or may determine a different availability state, for example, if the WTRU does not detect a signal associated with an availability state (e.g., a presence signal or an SSB) with a signal strength (e.g., at or) above the signal quality threshold. A criterion/condition may (e.g., also) be coupled with a lack of detection of an identifying sequence of the presence signal (e.g., detection of the PSS sequence).

A WTRU may (e.g., implicitly) determine an availability state associated with a cell, carrier, TRP, and/or frequency band (e.g., “Off,” “deep sleep,” “micro sleep,” or “dormant”), for example, based on time (e.g., time of day). For example, a WTRU may be configured to determine (e.g., automatically assume) a certain availability state (e.g., off, sleep, or dormant) for a configured subset of cells (e.g., capacity boosting cells) depending a time (e.g., a time of day). In some examples, a WTRU may determine that a capacity boosting cell has an availability state as “On” for a first configured time (e.g., hour(s) of the day), “Deep sleep” for a second configured time (e.g., hour(s) of the day), and/or “Off” for a third configured time (e.g., hour(s) of the day).

A WTRU may be configured to monitor an indication that may characterize a level of network activity (e.g., an availability state). Network activity may be associated with a network node (gNB) and/or a cell. A WTRU may determine (e.g., assume) the same availability state for multiple (e.g., all) cells that are part of the same node (e.g., gNB), e.g., cells of the same MAC entity. A network activity indication (e.g., a presence indication) may include a channel (e.g., a PDCCH) and/or a signal (e.g., a sequence). An activity indication may indicate a level of activity the WTRU may expect from the associated gNB and/or cell, e.g., reduced activity. An activity indication may include activity information of other gNBs/cells. An activity indication may be a PDCCH with group common signaling. For example, a NW may transmit a group common DCI to a group of WTRUs (e.g., WTRUs in the serving cell) indicating a change of an activity state or activity level in UL and/or DL. The CRC of the PDCCH may be scrambled with a dedicated “activity indication RNTI.” A WTRU may be configured with at least one search space associated with the monitoring occasions of the activity indication PDCCH. The indication may include, for example, a go-to-sleep signal, e.g., a (pre)defined/(pre)configured sequence. A WTRU may expect a reduced activity level (e.g., over a specific/configured time duration), for example, if/when the WTRU detects the sequence. A WTRU may activate connected mode DRX (C-DRX) for an indicated/configured period of time. In some examples, multiple (e.g., two) sequences may be used to indicate regular activity and reduced activity.

Signaling within a PDCCH or an activity indication may include, for example, at least one of the following: an expected activity level of the associated gNBs/cells over a time interval (e.g., an availability state); transmission and/or reception attributes for a (e.g., each) activity level (e.g., availability state); one or more (e.g., a set of) configurations that may be used/applied for associated/indicated activity level(s); a time interval over which an activity level is assumed (e.g., as may be signaled in the PDCCH or part of the activity indication); or a (pre)determined/(preconfigured time interval over which an activity level is determined (e.g., assumed).

Signaling within a PDCCH and/or an activity indication may include an expected activity level of the associated gNBs/cells over a time interval (e.g., an availability state). Activity levels may be predetermined and/or configured. Activity levels may include regular and reduced activity. The signaling may indicate the activity level. For example, bit “1” may indicate regular activity and bit “0” may indicate reduced activity.

Signaling within a PDCCH and/or an activity indication may include transmission and reception attributes for an (e.g., each) activity level (e.g., availability state). For example, a WTRU may (e.g., during reduced activity) not (e.g., be expected to) monitor certain PDCCH search spaces (e.g., including all SSs), receive a certain type of PDSCH (e.g., including all PDSCH), transmit PUCCH/PUSCH, and/or perform certain measurements.

Signaling within a PDCCH and/or an activity indication may include one or more (e.g., a set of) configurations associated with an activity level that may be used/applied if/when the activity level is indicated. Configurations associated with activity levels may indicate, for example, SS configurations, CSI reporting configurations, indices of transmitted SSBs, etc. A (e.g., each) set of configurations may have an attribute associated with an activity level. An attribute associated with an activity level may include, for example, a tag that can be set to “reduced activity.” Signaling within a PDCCH and/or an activity indication may include a time interval over which an activity level is determined/assumed. A time interval may be indicated, for example, using a bitmap. A (e.g., each) bit in the bitmap may be associated with a specific duration, e.g., a slot or a frame. For example, bit “1” may indicate regular activity and bit “0” may indicate reduced activity on an associated frame. A time interval may be indicated with a start time and/or an interval length. A start time may be determined, for example, by adding an (e.g., a fixed) offset to the time the indication is received. The length of the interval may be configured or signaled in the indication PDCCH.

A WTRU may be configured or predefined with an alternate serving cell to perform initial access, mobility, or cell reselection, for example, in the event a current serving cell or a capacity boosting cell is turned off and/or if a certain (e.g., configured, indicated, specified) condition is met. A WTRU may be configured (e.g., per broadcast signaling or dedicated signaling) with a list of fallback or alternate serving cells (e.g., per serving cell or per gNB). For example, a WTRU may initiate a cell reselection and/or mobility procedure to an alternate serving cell associated with a cell or gNB from which a turn-off indication was received. In some examples, a turn off or go-to-sleep indication may (e.g., dynamically) indicate to the WTRU which cell to fallback or connect to. An indication may be provided, for example, by dedicated or broadcast signaling. A fallback cell may be (pre)configured/(pre)defined as a master node cell, for example, if a WTRU is in dual connectivity. A fallback/alternate cell may be (pre)configured or (pre)defined to be a cell associated with a different RAT or frequency band. For example, a WTRU may fall back to an LTE or an FR1 cell associated with the cell or gNB from which the turn off indication was received (e.g., if the WTRU is in carrier aggregation (CA) or dual connectivity (DC) using multiple RATs or multiple frequency bands).

A WTRU may determine that an uplink or downlink resource and/or signal are available for transmission/reception and/or measurements for the determined network availability state, for example, if applicable in the active availability state. A WTRU may determine that one or more (e.g., a subset of) measurement resources and/or signals (e.g., SSBs, CSI-RS, TRS, PRS) are not applicable in one or more (e.g., certain) availability states. A WTRU may determine that one or more (e.g., a subset of) uplink or downlink resources (e.g., PRACH, PUSCH, PUCCH) are not applicable in certain availability states. A WTRU may transmit one or more (e.g., some) uplink signals, for example, (e.g., only) in a subset of NW availability states (e.g., sounding reference signal (SRS), periodic SRS (pSRS), PRACH, UCI).

A cell presence indication may be provided. A WTRU may monitor for reception of a presence indication or signal associated with a gNB configured with one or more availability states (e.g., on, off, dormant, and/or deep sleep). A presence indication may be a physical downlink signal transmitted by the associated cell or gNB that is sleeping, e.g., in certain availability states, such as deep sleep, micro sleep, dormant, or off. A presence indication may (e.g., alternatively) be downlink information (e.g., downlink information bits) that are delivered to the WTRU, for example, by broadcast signalling (e.g., system information block (SIB)) or by dedicated signalling (e.g., RRC signalling or MAC CE).

A WTRU may change to an availability state based on/associated with (e.g., detection of) a presence signal (e.g., WTRU assume “On”). For example, a WTRU may (e.g., successfully) receive a response from a requested cell. A response may be provided to transmitted WTRU assistance information or a switch-on request. A response may be the reception of a DL signal or channel (e.g., SSB(s), CSI-RS, PRS, PDCCH, DCI, PDSCH, HARQ-ACK) or an L2 message (e.g., an RRC message, DL MAC CE, Msg2, MsgB, or Msg4). A WTRU may monitor (e.g., start monitoring) additional TRPs, SSBs and/or CSI-RS resources, for example, after the transmission of the wake-up WTRU assistance information or the switch-on request or successful reception of a response. A WTRU may change to an availability state associated with detecting a presence signal (e.g., On), for example, after the WTRU (e.g., successfully) measures channel conditions (e.g., RSRP, SINR) on measurement resources of the associated cell above a configured threshold.

A presence indication signal may be, for example, at least one of the following: a simplified or stripped down SSB signal, e.g., PSS/SSS without PBCH multiplexed, a wide beam or omni-directional SSB, a PRS, a CSI-RS, a signal detected based on energy sensing (e.g., a DL signal associated with a wake-up radio, for example, if the WTRU is equipped with a capability to detect the DL signal), a PDSCH or PDCCH received on a different cell or TRP (e.g., on a configured subset of resources), CORESETs, or search spaces, and/or one or more SSBs received on a different cell or TRP (e.g., configured on a subset of SSB occasions).

Energy savings may be provided by downlink power reduction. A gNB may implement network energy savings by reducing downlink transmission power, for example, when there is little traffic. WTRU's that would fall out of coverage after the reduction of downlink power may be offloaded to neighboring gNB's. Network energy savings may (e.g., additionally and/or alternatively) be implemented, for example, by reducing the number of antenna elements for downlink transmission. A network may (e.g. dynamically) adapt transmission power parameters, e.g., on per-TRP basis, for example, to maximize performance. A gNB may be configured (e.g., have the ability) to perform adjustments, which may depend on the physical channel and/or signal being transmitted.

A WTRU may provide CSI feedback. A network (e.g., NR) may support CSI feedback reporting from a WTRU, for example, to enable adaptation of PDSCH transmission parameters, such as a modulation and coding scheme (MCS). A WTRU may determine CSI, for example, based on measuring at least one CSI reference signal (CSI-RS) representing a desired channel or interference. A WTRU may determine (e.g., assume) a (e.g., certain) power offset between the reference signal (RS) and the PDSCH that would be transmitted. The power offset may be configured for a (e.g., each) reference signal (e.g., IE powerControl Offset within NZP-CSI-RS-Resource).

A power offset between CSI-RS and PDSCH, which may be assumed by a WTRU for CSI feedback, may be different from the power offset used, for example, if the gNB dynamically changes PDSCH power for energy savings, e.g., especially if/when the power offset is configured semi-statically per a CSI-RS resource that may be shared with multiple WTRUs. A different power offset between CSI-RS and PDSCH may (e.g., additionally) affect the quality of equalization at a WTRU receiver side. A CSI report may not be useful. Performance may suffer, e.g., based on an inaccurate CSI report. A network may configure multiple CSI report configurations to obtain feedback from multiple possible offsets (e.g., between the observed PDSCH received power and the configured value), which may result in high overhead on RRC (e.g., due to duplication of configurations), high overhead on PUCCH (e.g., for the actual reporting), and/or power estimation errors by the WTRU(s). Similar problems may occur, for example, if the network dynamically switches (e.g., turns on or off) transmission from a subset of antenna ports for PDSCH.

Some WTRUs (e.g., WTRUs in cell center conditions) may experience received PDSCH power and SINR much higher than needed to sustain a selected MCS. Paging area (PA) power may be set jointly for multiple (e.g., all) WTRUs in a cell, for example, to meet link budget constraints for the cell. A gNB may be transmitting with much higher power than needed for WTRUs with good coverage, which may result in transmitting more power than needed and consuming unnecessary energy. The PDSCH power for a cell center WTRU may be dynamically reduced, for example, based on a WTRU's channel conditions, e.g., on a per-WTRU basis. Dynamic reduction of PDSCH power may result in a WTRU assuming a power offset between CSI-RS and PDSCH for CSI feedback different from the power offset (e.g., semi-statically) configured for the CSI-resource.

A device (e.g., a WTRU) may include a processor configured to perform one or more actions.

The device may receive configuration information. The configuration information may indicate a power offset associated with a channel state information reference signal (CSI-RS) resource. The configuration information may indicate that the CSI-RS resource is associated with a CSI-RS power offset group. The device may receive a power offset change indication that indicates a power offset change for the CSI-RS power offset group. The device may determine an adjusted power offset associated with the CSI-RS resource based on the power offset and the power offset change for the CSI-RS power offset group. The device may determine CSI feedback based on a measurement associated with the CSI-RS resource and the adjusted power offset associated with the CSI-RS resource. The device may send a CSI feedback report (e.g., to a network). The CSI feedback report may include an indication of the CSI feedback.

A device (e.g., a WTRU) may include one or more of: a memory, a receiver and a transmitter (e.g., a transceiver), or a processor, where the device is configured to perform one or more actions. The device may receive configuration information. The configuration information may indicate a power offset associated with a first channel state information reference signal (CSI-RS) resource. The device may receive a power offset change for the first CSI-RS resource. The device may determine an adjusted power offset associated with the first CSI-RS resource based on the power offset associated with the first CSI-RS resource and the power offset change for the first CSI-RS resource. The device may determine CSI feedback for the first CSI-RS resource based on a measurement associated with the first CSI-RS resource and the adjusted power offset associated with the first CSI-RS resource. The device may send a send a CSI feedback report. The CSI feedback report may indicate the CSI feedback for the first CSI-RS resource.

The configuration information may indicate a power offset associated with a second CSI-RS resource. The device may receive a power offset change for the second CSI-RS resource. The device may determine an adjusted power offset associated with the second CSI-RS resource based on the power offset associated with the second CSI-RS resource and the power offset change for the second CSI-RS resource. The device may determine CSI feedback for the second CSI-RS resource based on a measurement associated with the second CSI-RS resource and the adjusted power offset associated with the second CSI-RS resource. The CSI feedback report may include an indication of the CSI feedback for the second CSI-RS resource.

The CSI feedback report may include an indication of the adjusted power offset associated with the first CSI-RS resource and the adjusted power offset associated with the second CSI-RS resource.

The first CSI-RS resource may be a first non-zero-power (NZP) CSI-RS resource and the adjusted power offset associated with the first CSI-RS resource may be determined to be a ratio of physical downlink shared channel (PDSCH) energy-per-resource-element (EPRE) to NZP CSI-RS EPRE.

The first CSI-RS resource may be a first non-zero-power (NZP) CSI-RS resource. The configuration information may include a NES state index, a number of antenna ports associated to the NES state index, and/or an association of a variable antenna ports group to the first CSI-RS resource. The device may determine a number of antenna ports for the first CSI-RS resource based on the number of antenna ports associated to the NES state index.

The CSI feedback report may be based on the determined number of antenna ports for the first CSI-RS resource.

The adjusted power offset associated with the first CSI-RS resource may be the sum of the power offset associated with the first CSI-RS resource and the power offset change for the first CSI-RS resource.

A method for wireless transmit/receive unit (WTRU) operation in a network with variable power transmissions (e.g., based on an energy saving mode of operation) may be performed. The method may include receiving configuration information. The configuration information may indicate a power offset associated with a first channel state information reference signal (CSI-RS) resource. The method may include receiving a power offset change for the first CSI-RS resource. The method may include determining an adjusted power offset associated with the first CSI-RS resource based on the power offset associated with the first CSI-RS resource and the power offset change for the first CSI-RS power offset group. The method may include determining CSI feedback for the first CSI-RS resource based on a measurement associated with the first CSI-RS resource and the adjusted power offset associated with the first CSI-RS resource. The method may include sending a CSI feedback report. The CSI feedback report may include an indication of the CSI feedback for the first CSI-RS resource.

The configuration information may indicate a power offset associated with a second CSI-RS resource. The method may include receiving a power offset change for the second CSI-RS resource, determining an adjusted power offset associated with the second CSI-RS resource based on the second power offset associated with the second CSI-RS resource and the power offset change for the second CSI-RS resource, and determining CSI feedback for the second CSI-RS resource based on a measurement associated with the second CSI-RS resource and the adjusted power offset associated with the second CSI-RS resource. The CSI feedback report may include an indication of the CSI feedback for the second CSI-RS resource.

A device (e.g., a WTRU) may include one or more of: a memory, a receiver and a transmitter (e.g., a transceiver), or a processor, where the device is configured to perform one or more actions. The device may receive configuration information. The device may receive configuration information, wherein the configuration information indicates a first power offset associated with a first channel state information reference signal (CSI-RS) resource. The device may receive a second power offset associated with the first CSI-RS resource. The device may determine CSI feedback based on a measurement associated with the first CSI-RS resource and the second power offset. The device may send a CSI feedback report. The CSI feedback report may include an indication of the CSI feedback.

The configuration information may indicate that the first CSI-RS resource is associated with a first CSI-RS power offset group.

The indication of the second power offset may be received after the indication of the first power offset. The device may determine that the second power offset is a last received power offset. The device may to determine CSI feedback based on the last received power offset (e.g., the second power offset).

Use of a power offset in the determination of the CSI feedback may be limited to use of the last received power offset.

Power offset assumptions may be dynamically changed for CSI-RS resources (e.g., as described herein, power offset changes may be dynamically signaled to a WTRU that cause the WTRU to change its power offset assumptions).

A WTRU may report CSI (e.g., CSI feedback as described herein) using assumptions for a PDSCH transmission power. The assumptions for the PDSCH transmission power may be dynamically changed. CSI reports may be generated without incurring excessive overhead.

A WTRU may receive an indication (e.g., in signaling) to set or adjust the value of at least one parameter that the WTRU uses to calculate (e.g., and report) CSI.

Network energy saving (NES) operation mode(s) may be used (e.g., by a gNB). In examples, a node may dynamically switch between multiple NES operation modes based on NES scheme(s). A first NES operation mode may be a normal mode (e.g., without power constraint(s) and a second NES operation mode may be an energy saving mode (e.g., with power constraint(s). A gNB may perform transmission/reception in the first NES operation mode (e.g., normal mode) without one or more network energy saving schemes. A gNB may perform transmission/reception in the second NES operation mode (e.g., energy saving mode) with at least one network energy saving scheme.

NES schemes and/or availability states may include one or more of the following (e.g., at gNB(s): ON/OFF transmission or reception; transmission power level changes; ON/OFF operation of one or more antenna ports; relaxed (e.g., reduced) requirements for transmit/receive antennas; or offloading WTRUs to neighboring cell(s) or gNB(s).

NES schemes may specify ON/OFF transmission or reception (e.g., at a gNB). For example, a NES scheme may turn ON or may turn OFF downlink transmission(s) for time resource(s) and/or frequency resource(s). In examples, a NES scheme may turn OFF all time/frequency resource(s) (e.g., to reduce energy usage).

NES schemes may specify transmission power level changes (e.g., at a gNB). For example, a NES scheme may specify transmission power level changes should occur in a dynamic manner or semi-static manner.

NES schemes may specify ON/OFF operation of antenna port(s) (e.g., each antenna port) (e.g., at a gNB). For example, an NES scheme may specify OFF operation (e.g., no operation) for all antenna port(s) of a gNB.

NES schemes may specify relaxed (e.g., reduced) requirements for transmit/receive antenna(s) (e.g., at a gNB). For example, relaxed radio frequency (RF), error vector magnitude (EVM), etc. requirements for transmit/receive antenna(s) (e.g., each transmit/receive antenna) may be specified by an NES scheme.

NES schemes may specify offloading WTRU(s) (e.g., from a gNB) to neighboring cell(s) (e.g., or gNB(s).

NES scheme(s) may inform selection, determination, or configuration of NES operation mode(s). An NES operation mode (e.g., each NES operation mode) may be selected, determined, and/or configured (e.g., for use) based on which (e.g., subset of) NES scheme(s) are in use. An NES scheme may be selected, determined, and/or configured (e.g., for use) based on which NES operation mode is in use. For example, a first subset of NES schemes may be used if/when a first NES operation mode is used, configured, or determined; a second subset of NES schemes may be used if/when a second NES operation mode is used; and a third subset of NES schemes may be used if/when a third NES operation mode is used. A subset (e.g., a subset of NES schemes) may include (e.g., be) an empty set.

NES operation mode may be interchangeably used with availability states, network availability states, NES states, NES status, NES configuration, NES mode, and NES case.

Power control offset adaptation may be provided for one or more parameters.

A parameter (e.g., for power control offset adaptation) may be, for example, an assumed ratio of PDSCH energy-per-resource-element (EPRE) to non-zero-power (NZP) CSI-RS resource for at least one NZP CSI-RS resource configured for channel or interference measurement. In some examples, signaling may (e.g., directly) indicate an applicable value of the ratio, e.g., in dB. Signaling may (e.g., alternatively) indicate an adjustment of the ratio, for example, compared to the value (e.g., of the ratio) configured by RRC for the NZP CSI-RS resource (e.g., by powerControlOffset information element (IE)).

The value (e.g., in dB) of the ratio of PDSCH energy-per-resource-element (EPRE) to CSI-RS resource for a CSI-RS resource may be referred to as a power offset.

For example, the CSI feedback may be determined based on a measurement associated with a CSI-RS resource and a received power offset (e.g., a last received power offset), for example based on the measurement associated with a CSI-RS resource and only the last received power offset. The power offset may be directly received (e.g., from a network node). The power offset may be used (e.g., as received) as an offset to the measurement to determine CSI feedback for the associated CSI-RS resource. The power offset may be used (e.g., as received) to determine CSI feedback for a power offset group associated with the respective CSI-RS resource.

In examples, a signaled ratio (e.g., power offset) may be considered an adjusted ratio (e.g., an adjusted power offset) (e.g., if the signaled ratio incorporates an adjustment to a power offset previously associated with a CSI-RS resource). The signaled ratio (e.g., power offset or adjusted power offset) may be used by a WTRU when determining CSI-RS resource feedback. CSI feedback may be based on the ratio (e.g., power offset) that was last received by the WTRU. In examples, a WTRU may determine CSI feedback for a CSI-RS resource based on the last received power offset (e.g., without consideration of a previously associated power offset or a power offset change, such as described herein). A power offset for a CSI-RS resource may be signaled (e.g., without a power offset change) and used to determine CSI feedback.

Signaling may (e.g., alternatively) indicate an adjustment (e.g., power offset change) to be made to a ratio (e.g., power offset) previously associated with a CSI-RS resource. In examples a power offset change may be signaled (e.g., without a power offset or an adjusted power offset). A WTRU may determine an adjusted power offset for a CSI-RS resource based on a power offset previously associated with the CSI-RS resource (e.g., the last received power offset associated with the CSI-RS resource) and the received power offset change. The adjusted power offset may be the sum of the previously associated power offset and the power offset change.

A WTRU may adjust a ratio (e.g., the ratio previously configured by configured by RRC for the NZP CSI-RS resource, for example, by powerControlOffset information element (IE)) based on a signaled power offset change. The adjusted ratio (e.g., adjusted power offset) may be the sum of the power offset (e.g., a previously associated power offset) and the received adjustment (e.g., the power offset change).

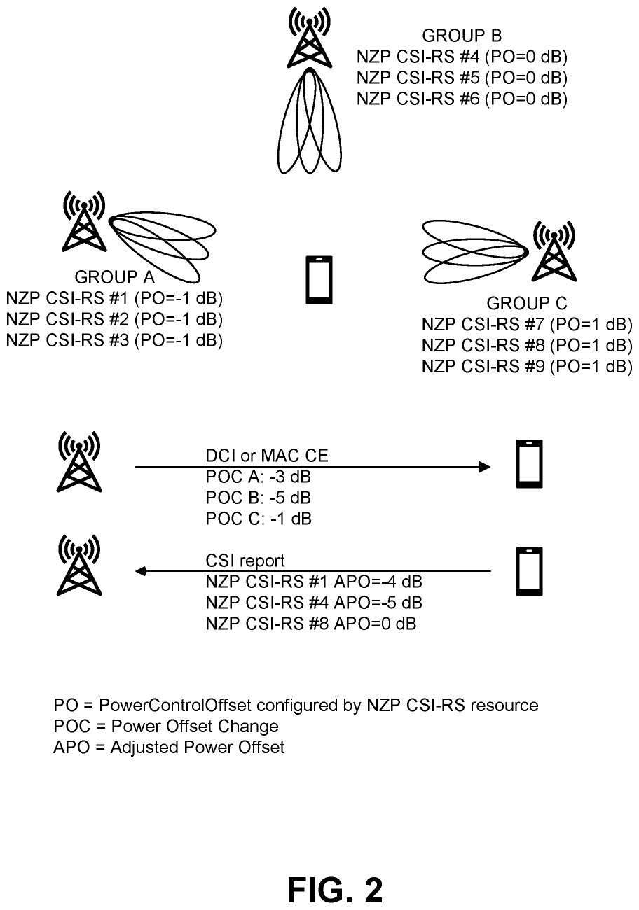

For example, the value of a power offset (e.g., powerControlOffset) may be −3 dB and the value of the power offset adjustment (e.g., power offset change) may be −2 dB. The WTRU may determine that the adjusted ratio (e.g., adjusted power offset) to be used when determining CSI feedback is −5 dB (e.g., the sum of −3 dB and −2 dB); see FIG. 2.

A WTRU may adjust (e.g., via receipt of a power offset change) or replace (e.g., via receipt of an adjusted power offset) a ratio (e.g., power offset) associated with a CSI-RS resource.

A parameter (e.g., for power control offset adaptation) may be, for example, an assumed ratio of NZP CSI-RS to secondary synchronization signal (SSS) EPRE. Signaling may (e.g., directly) indicate an applicable value of the ratio (e.g., in dB). Signaling may (e.g., alternatively) indicate an adjustment of the ratio, for example, compared to the value (e.g., of the ratio) configured by RRC for the parameter (e.g., from powerControlOffsetSS IE).

Adaptation of the number of antenna ports may be provided for one or more parameters.

A parameter (e.g., for adaptation of the number of antenna ports) may be an assumed number of antenna ports for at least one NZP CSI-RS resource configured for channel or interference measurement. In some examples, signaling may (e.g., directly) indicate an applicable value/number of the parameter. Signaling may (e.g., alternatively) indicate an adjustment of the value/number, for example, compared to the value configured by RRC for the NZP CSI-RS resource (e.g., by nrofPorts IE). Signaling may (e.g., alternatively) indicate an adjustment of the number compared to a previously adjusted value.

In some examples, a WTRU may be configured with an NZP-CSI-RS for a channel or interference measurement. The number of antenna ports for the NZP-CSI-RS may be determined, for example, based on one or more of following: a configuration (e.g., the number of antenna ports configured as an NZP-CSI-RS); an NES operation mode; and/or a CSI reporting configuration.

In some examples, the number of antenna ports for an NZP-CSI-RS may be determined (e.g., at least) based on an (e.g., a determined) NES operation mode. For example, a first number of antenna ports (Np, 1) may be configured as an NZP-CSI-RS. A second number of antenna ports may be determined based on the first number of antenna ports. An offset may be configured (e.g., N_{offset}). For example, the second number of antenna ports (Np,2) may be as a function of Np,1 and N_{offset} (e.g., Np,2=Np,1−N_{offset}). For example, one or more numbers of antenna ports may be configured for an NZP-CSI-RS. A first number of antenna ports may be used or determined for a first NES operation mode. A second number of antenna ports may be used or determined for a second NES operation mode. For example, the number of antenna ports for an NZP-CSI-RS in a first NES operation mode (e.g., normal mode) may be smaller than the number of antenna ports for the NZP-CSI-RS in a second operation mode (e.g., energy saving mode).

In some examples, one or more NZP-CSI-RS resources may be configured for a CSI reporting configuration. A subset of an NZP-CSI-RS for channel/interference measurement may be determined, for example, based (e.g., at least) on an NES operation mode.

In some examples, a first number of antenna ports (Np,1) and a second number of antenna ports (Np,2) may be different for an NZP-CSI-RS. The second number of antenna ports (Np,2) may be smaller than first number of antenna ports (Np,1). The antenna ports for Np,2 may be a subset of the antenna ports for Np,1. One or more of the following may apply (e.g., alone or in any combination).

A WTRU may use previously measured channel/interference information from Np,1, for example, if/when the number of antenna ports is changed to Np,2 due to an NES operation mode switch.

A subset of antenna ports associated with Np,2 may be configured (e.g., via RRC or MAC-CE) and/or dynamically indicated (e.g., via DCI). For example, a bitmap may be used to indicate the subset of antenna ports. A group index may be used to indicate the subset of antenna ports. A (e.g., each) group index may be associated with a set of antenna ports. A subset may be determined, for example, based on an increasing/decreasing order of the antenna port index.

A CSI reporting configuration (e.g., report setting, resource setting) may change and/or may be determined, for example, based on the number of antenna ports for NZP-CSI-RS that are determined and/or used.

The periodicity of NZP-CSI-RS may be determined, for example, based on the number of antenna ports determined for the NZP-CSI-RS resource.

Applicable NZP CSI-RS resource(s) may be determined, for example, by one or more of the following: direct reference, reference to an NZP CSI-RS resource set, reference by a CSI report and/or CSI associated report, and/or reference by group identity.

Applicable NZP CSI-RS resource(s) may be determined by direct reference. In some examples, signaling may indicate the applicable NZP CSI-RS resource(s) by directly referring to the identity of the resource, e.g., nzp-CSI-RS-ResourceId IE. For example, a WTRU may receive a MAC CE, e.g., including the NZP CSI-RS resource ID and/or the applicable value of a parameter.

Applicable NZP CSI-RS resource(s) may be determined by reference to an NZP CSI-RS resource set. In some examples, signaling may indicate the applicable NZP CSI-RS resource(s) by referring to the identity of a resource set, e.g., including the resource, e.g., nzp-CSI-RS-ResourceSetId IE.

Applicable NZP CSI-RS resource(s) may be determined by reference by a CSI report and/or a CSI associated report. In some examples, the applicable NZP CSI-RS resource(s) may include one or more (e.g., all) NZP CSI-RS resources for channel and/or interference measurements for a CSI report configuration and/or a CSI associated report configuration, e.g., which may be configured for a certain aperiodic CSI trigger state. For example, the value of at least one parameter may be included as an IE in CSI-AssociatedReportConfigInfo. A first parameter may be for NZP CSI-RS resources for a channel. A second parameter may be for NZP CSI-RS resources for interference. In some examples, a (e.g., single) parameter may be applied to multiple (e.g., all) NZP CSI-RS resources. A WTRU may apply the parameters, for example, if/when determining aperiodic CSI (A-CSI) triggered for the corresponding trigger state.

Applicable NZP CSI-RS resource(s) may be determined by reference by a group identity. In some examples, a WTRU may (e.g., first) receive an indication (e.g., signaling) associating an NZP CSI-RS resource to a group, e.g., for at least one NZP CSI-RS resource. A group may be referred to, for example, as a “variable power offset group” or as a “variable antenna ports group.” The association may be indicated, for example, by configuring (e.g., by RRC) a set of groups and a list of NZP CSI-RS resources for each group. The association may be indicated (e.g., alternatively), for example, by adding a group identity IE to a (e.g., each) NZP CSI-RS resource configuration (nzp-CSI-RS-Resource). The association may be indicated (e.g., signaled), for example, by a MAC CE. The indication (e.g., signal) may include, for example, at least one NZP CSI-RS resource identity and at least one group identity. The WTRU may (e.g., further) receive signaling by MAC CE or DCI, which may indicate a group identity and/or an applicable value for at least one parameter (e.g., an additional power offset and/or a number of antenna ports). For example, signaling may include WTRU-group common signaling, such as a DCI received in a WTRU-group common search space. The WTRU may apply the received value to one or more (e.g., all) NZP CSI-RS resources associated with the indicated group for determining at least one CSI report. A group identity permits signaling to a group of WTRUs, e.g., instead of individual signaling to each WTRU.

A WTRU may determine applicable CSI reports. A WTRU may determine CSI (e.g., using dynamic adaptation as described herein), for example, (e.g., only) for applicable CSI reports. A WTRU may determine CSI differently (e.g., according to legacy CSI determinations), for example, for other CSI reports. A WTRU may determine applicable CSI report(s), for example, using one or more of the following examples.

In some examples, a WTRU may receive an indication (e.g., a configuration of) whether dynamic adaptation is applicable for a (e.g., each) CSI report configuration and/or CSI associated report configuration. For example, an IE within CSI-ReportConfig or CSI-AssociatedReportConfigInfo may indicate whether dynamic adaptation is applicable to one or more CSI reports generated for a configuration and/or a trigger state.

In some examples, a WTRU may receive an indication (e.g., a configuration) associating a process identity (such as an “adaptation process identity”) to a CSI report configuration and/or a CSI associated report configuration. For example, an IE within CSI-ReportConfig or CSI-AssociatedReport ConfigInfo may indicate the adaptation process identity or a MAC CE may provide an association between the CSI report configuration identity and the adaptation process identity. The WTRU may (e.g., further) receive an indication (e.g., signaling) indicating at least one of the following: at least one value of a parameter, at least one NZP CSI-RS resource (e.g., as described herein), and/or an adaptation process identity. The WTRU may apply the adaptation of the indicated parameter to the indicated NZP CSI-RS, for example, (e.g., only) for the CSI reports corresponding to a CSI (e.g., an associated CSI) reporting configuration configured with, or associated with, the indicated adaptation process identity.

Changes of value may be indicated (e.g., signaled). A change of at least one value applicable to at least one NZP CSI-RS resource and/or CSI report configuration may be indicated (e.g., signaled), for example, using one or more of the following examples.

Indications (e.g., signaling) of changes in values may be provided, for example, at the physical layer, such as one or more fields in a scheduling DCI, one or more fields or an aperiodic CSI trigger field in a DCI scheduling a PUSCH, one or more fields in a DCI format for WTRU-group common signaling, and/or by MAC CE. Signaling may be part of an availability state indication.

Signaling may include (e.g., for at least one group identity) a field indicating a power offset adjustment or a value and/or a field indicating a number of antenna ports (e.g., or a subset of antenna ports). The mapping between a (e.g., each) possible value of a field and a corresponding value for a power offset adjustment or value, and/or the number of antenna ports, may be (pre)defined and/or signaled by MAC CE or RRC.

In some examples, a WTRU may (e.g., first) receive signaling associating a state identity (e.g., an availability state) with a set of values for at least one parameter that may be adapted. For example, a WTRU may receive an indication (e.g., a configuration or signaling), e.g., by RRC or MAC CE, for a number of antenna ports (e.g., or a subset of antenna ports) and an assumed power ratio corresponding to a state identity for a NZP CSI-RS resource, e.g., for at least one state identity and NZP CSI-RS resource. The WTRU may (e.g., then) receive signaling indicating at least one NZP CSI-RS resource (e.g., using a group identity) and a state identity. The WTRU may (e.g., then) apply the values of the parameters to the NZP CSI-RS resource associated with a state identity for the calculation and reporting of CSI.

A WTRU may indicate an applied assumption in a CSI report. For example, a WTRU may include an indication of one or more applied assumptions for the calculation of CSI as part of or along with the CSI report. A WTRU may (e.g., alternatively) signal an indication separately (e.g., using a MAC CE). An indication (e.g., a separate indication) of applied assumption(s) may be triggered, for example, by reception of an indication (e.g., signaling) indicating a change of assumption(s) (e.g., as described herein). An indication of applied assumption(s) may have the same format as an indication (e.g., signaling) for a change of value (e.g., as described herein). For example, an indication of applied assumption(s) may include a state indication. Signaling an indication of applied assumption(s) may support (e.g., ensure) alignment between a WTRU and a network on the assumptions used for CSI calculation.

FIG. 2 illustrates an example of dynamic power adaptation for CSI measurements and feedback in a variable power network.

In examples of dynamic power adaptation (e.g., as shown by example in FIG. 2) one or more of the following may be performed.

A WTRU may receive a CSI resource configuration. The CSI resource configuration may include (e.g., indicate) at least one resource (e.g., non-zero-power (NZP) CSI-RS resource used as an example) for channel and/or interference measurements. A configuration of a NZP CSI-RS resource (e.g., each NZP CSI-RS resource) may include an assumed ratio of PDSCH energy-per-resource-element (EPRE) to NZP CSI-RS EPRE (e.g., powerControlOffset).

The WTRU may receive an indication (e.g., a configuration) associating a variable power offset group (e.g., group A, group B, group C) to each of the at least one NZP CSI-RS resources (e.g., NZP CSI-RS #1-#9); see FIG. 2. As shown in FIG. 2, the NZP CSI-RS resources (e.g., each of the NZP CSI-RS resources) may be indicated as having a power offset (e.g., which may be signaled to the WTRU, for example as powerControlOffset).

As shown in FIG. 2, the WTRU may receive signaling (e.g., WTRU-group common signaling) indicating a power offset change (POC) for a group or groups. As shown in FIG. 2, the variable (e.g., dynamic) signaling indicates a POC example of −3 dB for variable power offset group A, −5 dB for variable power offset group B, and −1 dB for variable power offset group C.

As shown in FIG. 2, the WTRU may determine an adjusted power offset (APO), for example, based on the power offset and the POC, e.g., as the sum of the powerControlOffset configured for a resource and the indicated POC. The WTRU may determine an APO for a NZP CSI-RS resource (e.g., each NZP CSI-RS resource) associated with the indicated variable power offset group. For example, as shown in FIG. 2, a WTRU may determine an APO of −4 dB for resource NZP CSI-RS #1 associated with variable power offset group A. The APO may be determined (e.g., by the WTRU) as the sum of the power offset (PO) (e.g., −1 dB) and the indicated POC of group A to which NZP CSI-RS #1 belongs (e.g., −3 dB).

As shown in association with FIG. 2, the WTRU may determine (e.g., derive) CSI feedback (e.g., based on a measurement associated with a CSI-RS resource and a POC associated with the resource) and send a CSI feedback report. In some examples, the determination may assume that the ratio of PDSCH energy-per-resource-element (EPRE) to NZP CSI-RS EPRE for each NZP CSI-RS resource is the determined Adjusted Power Offset (APO) for the resource. The WTRU may send (e.g., report) the CSI feedback to the network, e.g., where the report may indicate the determined CSI feedback (e.g., the value of the measurement as adjusted by the APO as shown in association with FIG. 2).

In examples, a WTRU may receive configuration information (e.g., from a network). The configuration information may indicate a power offset associated with a channel state information reference signal (CSI-RS) resource. The configuration information may indicate that the CSI-RS resource is associated with a CSI-RS power offset group.

The WTRU may receive configuration information for multiple CSI-RS resources. CSI-RS resources may be associated with different power offset groups. Different power offset groups may have the same power offset (e.g., powerControlOffset).

The WTRU may receive a POC indication (e.g., from the network). The POC indication may indicate a POC associated with a power offset group (e.g., each power offset group). A CSI-RS resource may be determined to be associated with a POC if the POC is associated with a power offset group that itself is associated with the CSI-RS resource.

The WTRU may determine an adjusted power offset associated with a CSI-RS resource (e.g., each CSI-RS resource, for example each CSI-RS resource in a power offset group). The adjusted power offset may be based on the power offset (e.g., the power offset indicated by the received configuration information) and the power offset change (e.g., the POC indicated by the received POC indication) that are associated with the respective CSI-RS resource (e.g., or a respective power offset group).

The WTRU may determine CSI feedback for a CSI-RS resource based on a measurement (e.g., CSI measurement) associated with the CSI-RS resource and the adjusted power offset associated with the CSI-RS resource (e.g., or a respective power offset group).

The WTRU may send a CSI feedback report. The CSI feedback report may include an indication of the determined CSI feedback.

In an example of dynamic antenna port adaptation, a WTRU may receive a CSI resource configuration, which may include at least one non-zero-power (NZP) CSI-RS resource for channel and/or interference measurements. A configuration of a (e.g., each) NZP CSI-RS resource may include a number of antenna ports (nrofPorts).

The WTRU may receive a configuration for at least one combination of an NES state index and a number of antenna ports associated with the NES state index.

The WTRU may receive a configuration associating a Variable Antenna Ports Group to each of the at least one NZP CSI-RS resources.

The WTRU may receive signaling (e.g., WTRU-group common signaling) indicating an NES state index and a Variable Power Offset Group.

The WTRU may determine the number of antenna ports (e.g., or subset of antenna ports) for an NZP CSI-RS resource, for example, as the number of antenna ports associated with the received NES state index. The WTRU may determine the number of antenna ports (e.g., or subset of antenna ports) for each of at least one NZP CSI-RS resource associated with the indicated Variable Antenna Ports Group.

The WTRU may derive CSI and report CSI feedback, e.g., assuming the number of antenna ports (e.g., or subset of antenna ports) used is the number of antenna ports (e.g., or subset of antenna ports) determined for each NZP CSI-RS resource.

In some examples, an NES state index may (e.g., also) be used in dynamic power adaptations (e.g., as described in examples provided herein). A “Variable Power Offset group” and/or a “Variable Antenna Ports Group”may be or may include a single parameter.

WTRU-assisted power adaptation may be provided.

In some examples, a WTRU may assist a network to determine an appropriate power reduction, e.g., a power spectral density (PSD), of PDSCH and/or certain (e.g., one or more) associated RS signals, e.g., through appropriate measurements and reporting. The power density of a PDSCH may be adapted (e.g., optimized), for example, on a per WTRU basis, which may reduce the energy consumption of the base station transmitter.

A WTRU may be in a very good channel condition (e.g., high CQI), for example, meaning a high SINR situation. A lower power spectral density (PSD) of the PDSCH allocated RBs may be sufficient/enough to achieve the same BLER target (e.g., using the same MCS). The WTRU may indicate/signal a very good channel condition (e.g., high CQI situation), for example, through one or more (e.g., adapted) measurements, which may support (e.g., allow for) dynamic power adaptation for base station transmissions.

A WTRU may assess channel conditions over/on a longer period. CSI feedback may be a punctual/dynamic assessment. CSI feedback may be periodic, semi-persistent (e.g., MAC-CE triggered) or aperiodic (e.g., DCI triggered). There may be a range of possible PDSCH power density reductions against the NZP-CSI-RS types that are used for TRS, PRS, or SSBs. There may be a limit for a PSD ratio between PDSCH and CSI-RS type signals. Resource element (RE) spillover into a neighboring RE may occur beyond the limit.

WTRU adapted measurements and triggers may be provided.

In some examples, a WTRU may signal a “Long-Term CSI Measurement” capability to a network. A base station may trigger long term CSI measurements for a WTRU, for example, after other (e.g., normal) CSI reporting from a WTRU and/or after a period where the WTRU PDSCH estimated BLER (e.g., through HRQ feedback) may provide a better indication than a threshold radio link condition (e.g., BLER below 3% or CQI above a threshold level over a certain period).

A measurement trigger command may be carried out by a base station, for example, through a MAC-CE for semi-persistent CSI-RS measurements or by a DCI order. A measurement may be confined within the BWP where the PDSCH is transmitted/scheduled.

A WTRU may (e.g., alternatively) be configured (e.g., semi-statically) with a radio link PDSCH quality threshold (e.g., a CQI threshold over a certain period and reporting conditions) that may trigger a long-term CSI measurement process and reporting on the WTRU side.

A long-term CSI measurement process may include, for example, a moving window average applied to a certain (e.g., selected, determined, indicated) number of CSI-RS opportunities (e.g., a semi-persistent or periodic CSI-RS). The average level that the measurement may be compared to may be signaled/configured, for example, by the base station (e.g., in terms of CQI), or the comparison level (e.g., moving average window) may be assumed by the WTRU as the last reported non-averaged value. The comparison level may (e.g., alternatively) be an SINR level that may be mapped to the last reported CQI.

The length of the moving average window may be configured, for example, by a base station, or may be assumed, e.g., as multiple (e.g., several) consecutive normal CSI feedback samples related to a configured periodic CSI feedback. The reporting may be (e.g., periodic) based on the average window, for example, if/when the long-term CSI measurement process is triggered.

The reporting may (e.g., alternatively) be based on degradation/improvement thresholds, e.g., acting as a hysteresis window. A report may be triggered, for example, if/when the low or high hysteresis thresholds are crossed for a certain period of time, which may reduce reporting overhead.

A period for the degradation/improvement reporting may be based on, for example, a counter for better than average threshold and/or a counter for worse than average threshold. The counters may be reset, for example, if/when the conditions indicated by measurements return within the hysteresis limits before a counter expiration (e.g., reaching reporting limits).

A base station may implement dynamic power adaptation.

A base station may transmit several signals and channels. A power adaptation of a PDSCH may have limits, for example, in terms of power difference between PDSCH allocated REs, CSI-RS, PRS, SSBs etc.

There may be a limit on the PSD difference between signals. For example, a maximum 6 dB difference limit may be implemented/used to avoid inter-RE distortion. A PDSCH power adaptation range may be limited to 6 dB range, following the above example, while maintaining the power density for (e.g., all) other channels and signals transmitted by the base station.

A power adaptation range may have a (e.g., specific, configured, defined, indicated, determined, selected) granularity. For example, a power step may be for example 1,2, or 3 dB. A PSD for a PDSCH may be increased or decreased in (pre)defined power steps.

In some examples, a power step down or up may be sent by a WTRU triggered by the moving averaged measurements results. For example, a quality improvement reporting condition may be accompanied by a power down indicator. A quality degradation reporting condition may be accompanied by a power up indicator. A WTRU may be configured with a period for the reporting. A WTRU may be configured to report measurements, for example, if the power offset from the desired goal is above a (pre)defined or (pre)configured threshold. A WTRU may report measurements conditionally, for example, (e.g., only) if the WTRU received signaling from the network (e.g., another PDSCH or DCI indication) since the last measurement report.

A WTRU may (e.g., alternatively) trigger a quality improvement/degradation. A base station may indicate a new ratio of an NZP-CSI-RS with the PDSCH, for example, assuming that the PDSCH power is changing.

An indication may be signaled through MAC-CE or DCI. An indication may be, for example, a multi-bit (e.g., two-bit) group that may map to the power adaptation granularity in steps and a bit indicating an up or down direction. An indication may (e.g., alternatively) be a (e.g., an explicit) value (e.g., in dB) and a sign (e.g., for up or down). An indication may (e.g., alternatively) be a bit that moves the ratio one step up or down (e.g., incrementally), for example, in an enumeration semi-statically configured or assumed by a WTRU.

PDSCH power reduction WTRU assistance information and feedback

An MCS may involve a signal-to-noise and interference ratio (SNIR) measured at a receive antenna) to operate with an acceptably low BER. An MCS with a higher throughput may utilize a higher SNIR to operate. Link adaptation works by measuring and feeding back the channel SNIR to the transmitter, which may choose a suitable MCS from a set of MCSs to maximize throughput at the SNIR. Throughput for a WTRU at cell center may not involve using the highest possible MCS for a WTRU's SNR, for example, given that the data rate may be lower.

In some examples (e.g., for a given MCS or CQI), a WTRU may report to a serving gNB the gap between the measured SNR or SINR and the nominal SNR needed to sustain using an MCS. A WTRU may report the gap for one or more MCSs or CQIs. The WTRU may report the MCS or CQI that (e.g., best) meets the WTRU's data rate requirement (e.g., number of bits per channel use, bits per slot or ms, etc.), for example, alternative to and/or in addition to the instantaneous CQI of the WTRU's channel. The WTRU may (e.g., further) report a different CSI-RS to PDSCH power offset, for example, based on the MCS that (e.g., best) meets the WTRU's data rate requirement. The WTRU may report feedback statistics to the gNB for the (e.g., two) MCS codepoints adjacent to the MCS used for the current or latest PDSCH transmission. The WTRU may provide PDSCH power reduction assistance information, for example, as part of UCI feedback, a MAC CE, or an enhanced CQI report.

In some examples, a WTRU may report a power step up or down, based on the difference between the measured SNR and the SNR threshold utilized (e.g., required) for the MCS. The WTRU may be configured with an SNR step size. The WTRU may report SNR up or down, for example, if the measured SNR doesn't change more than the step size. The WTRU may report an SNR up or down command, for example, if the measured SNR is within a certain gap from the SNR threshold (e.g., required) to meet the MCS's SNR threshold. For example, the WTRU may continue reporting SNR down until the measured SNR is within a (pre)configured or (pre)defined gap from the MCS's threshold.

A WTRU may provide PDSCH power reduction assistance feedback and/or apply procedures for WTRU adapted PDSCH power reduction measurements and reporting, for example, based on at least one of the following: the WTRU's measured channel condition(s) (e.g., SNR or RSRP) is(are) above a first threshold and/or below a second threshold; reception of an indication by DCI from the gNB (e.g., MAC-CE triggered or aperiodic DCI triggered); the MCS used; the WTRU speed; the WTRU's capability; and/or the WTRU's measured pathloss being above or below a threshold.

A WTRU may provide PDSCH power reduction assistance feedback and/or may apply one or more procedures for WTRU adapted PDSCH power reduction measurements and reporting, for example, based on the WTRU's measured channel conditions (e.g., SNR or RSRP) above a first threshold and/or below a second threshold. For example, a WTRU may report PDSCH power reduction assistance information if the WTRU's SNR is x dBs above the SNR threshold used (e.g., required) to meet the selected MCS.

A WTRU may provide PDSCH power reduction assistance feedback and/or may apply one or more procedures for WTRU adapted PDSCH power reduction measurements and reporting, for example, based on the MCS used. For example, the WTRU may provide assistance information if the MCS is from a configured or predetermined subset, and/or if the MCS is higher than an MCS codepoint (e.g., MCSs of 16 QAM and higher).

A WTRU may provide PDSCH power reduction assistance feedback and/or may apply one or more procedures for WTRU adapted PDSCH power reduction measurements and reporting, for example, based on the WTRU speed. For example, a WTRU may provide assistance information if the WTRU is not mobile (e.g., if measured channel conditions do not change more than a threshold amount) and/or if the WTRU's location doesn't change more than a threshold amount.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-18. (canceled)

19. A wireless transmit/receive unit (WTRU) comprising:
a processor configured to:
receive a first indication indicating first configuration information and second configuration information, wherein the first configuration information indicates a first power offset associated with a first group of channel state information reference signal (CSI-RS) resources and indicates a second power offset associated with a second group of CSI-RS resources, wherein the first group of CSI-RS resources comprises at least a first CSI-RS resource and a second CSI-RS resource, and wherein the second configuration information indicates a power control offset associated with the first CSI-RS resource;
receive a second indication that indicates to report CSI associated with the first group of CSI-RS resources;
determine CSI for the first CSI-RS resource based at least on the first power offset associated with the first group of CSI-RS resources and the power control offset associated with the first CSI-RS resource; and
send a CSI report, wherein the CSI report includes an indication of the CSI for the first CSI-RS resource.

20. The WTRU of claim 19, wherein the processor is further configured to:
determine an adjusted power offset associated with the first CSI-RS resource based on the first power offset associated with the first group of CSI-RS resources and the power control offset associated with the first CSI-RS resource; and
perform a measurement associated with the first CSI-RS resource based on the adjusted power offset, wherein the CSI for the first CSI-RS resource is further based on the performed measurement.

21. The WTRU of claim 20, wherein to determine the adjusted power offset associated with the first CSI-RS resource, the processor is further configured to:
subtract the first power offset associated with the first group of CSI-RS resources from the power control offset associated with the first CSI-RS resource.

22. The WTRU of claim 19, wherein the first indication is received via radio resource control (RRC) signaling.

23. The WTRU of claim 19, wherein the second indication is received via one of downlink control information (DCI) or a medium access control control element (MAC CE).

24. The WTRU of claim 19, wherein the first power offset associated with the first group of CSI-RS resources is different from the second power offset associated with the second group of CSI-RS resources.

25. A method comprising:
receiving a first indication indicating first configuration information and second configuration information, wherein the first configuration information indicates a first power offset associated with a first group of channel state information reference signal (CSI-RS) resources and indicates a second power offset associated with a second group of CSI-RS resources, wherein the first group of CSI-RS resources comprises at least a first CSI-RS resource and a second CSI-RS resource, and wherein the second configuration information indicates a power control offset associated with the first CSI-RS resource;
receiving a second indication that indicates to report CSI associated with the first group of CSI-RS resources;
determining CSI for the first CSI-RS resource based at least on the first power offset associated with the first group of CSI-RS resources and the power control offset associated with the first CSI-RS resource; and
sending a CSI report, wherein the CSI report includes an indication of the CSI for the first CSI-RS resource.

26. The method of claim 25, wherein the method further comprises:
determining an adjusted power offset associated with the first CSI-RS resource based on the first power offset associated with the first group of CSI-RS resources and the power control offset associated with the first CSI-RS resource; and
performing a measurement associated with the first CSI-RS resource based on the adjusted power offset, wherein the CSI for the first CSI-RS resource is further based on the performed measurement.

27. The method of claim 26, wherein to determine the adjusted power offset associated with the first CSI-RS resource, the method further comprises:
subtracting the first power offset associated with the first group of CSI-RS resources from the power control offset associated with the first CSI-RS resource.

28. The method of claim 25, wherein the first indication is received via radio resource control (RRC) signaling.

29. The method of claim 25, wherein the second indication is received via one of downlink control information (DCI) or a medium access control control element (MAC CE).

30. The method of claim 25, wherein the first power offset associated with the first group of CSI-RS resources is different from the second power offset associated with the second group of CSI-RS resources.
